(19) United States
(12) Patent Application Publication
(10) Pub. No.: US 2007/0167104 A1
(43) Pub. Date: Jul. 19, 2007

(54) METHOD FOR MANUFACTURING PROJECTION CATHODE RAY TUBE

(76) Inventors: Tetsuo Asano, Mobara (JP); Takashi Hoshimure, Ooamishirasato (JP); Sakae Watanabe, Mutsuzawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/624,242

(22) Filed: Jan. 18, 2007

(30) Foreign Application Priority Data
Jan. 19, 2006 (JP) 2006-010589

(51) Int. Cl. H01J 9/38; C23G 1/02

(52) U.S. Cl. 445/59; 134/41

(57) ABSTRACT

A vicinity part of a high-voltage feeding anode terminal, embedded in a funnel part and having a part thereof exposed on an outer wall surface of the funnel part, is washed with a hydrofluoric acid solution to remove a moisture-absorptive deposited substance adhering to the outer wall surface. According to a manufacturing method of this invention, anode leak failure due to unwanted discharge of the vicinity part of the high-voltage feeding anode can be restrained, and a projection cathode ray tube having an excellent display characteristic can be provided.

### BACKGROUND OF THE INVENTION

1. Field of the Invention

This invention relates to a method for manufacturing a projection cathode ray tube having an electron gun that ejects a single electron beam toward a fluorescent screen.

2. Description of the Related Art

A projection color image reproducing and display device such as a projection television receiver typically uses three dedicated projection cathode ray tubes devices for reproducing primary-color images of red, green and blue. Three primary-color images acquired by these three projection cathode ray tube devices are enlarged and thus projected on a screen by using an optical lens or mirror, and the three primary-color images are superimposed on the screen to form a color image. The projection cathode ray tube has a fluorescent screen diagonal of 5.5 inches or 7 inches, and the projection television receiver has a nominal screen diameter of 40 inches or 50 inches.

FIG. 5 is a schematic sectional view for explaining an exemplary structure of a projection cathode ray tube used for a projection display device. In FIG. 5, 1 denotes a panel part, 1a is a phosphor screen, 2 is a funnel part, 3 is a neck part, 4 is an electron gun, 5 is a single electron beam, 6 is an anode terminal, 7 is an interior conductive film, 8 is an exterior conductive film, 9 is a stem, 10 is a conductive pin, 11 is a evacuated envelope, and 12 is a deflector.

The electron gun 4 arranged in the neck part 3 has coaxially arranged plural electrodes, and each electrode is embedded and fixed and thus integrated in bead glass via a supporting unit. Each of the electrodes of the electron gun 4 is electrically connected with the conductive pin 10 of the stem 9, and a predetermined voltage is applied to each electrode, thus emitting the single electron beam 5 toward the fluorescent screen 1a. The anode terminal 6 is embedded in the funnel part 2 by hermetically penetrating the funnel part 2, and serves as a high voltage feeding terminal into the tube. A high voltage fed from the anode terminal 6 is applied to the fluorescent screen 1a, the electron gun 4 and the like via the interior conductive film 7. The interior conductive film 7 is made of a mixed material of, for example, graphite, water glass and the like. The interior conductive film 7 is formed by coating over an entire inner wall surface 2a of the funnel part 2 and has continuity to each of the anode terminal 6, the fluorescent screen 1a, the electron gun 4 and the like.

The exterior conductive film 8 is made of a mixed material of, for example, graphite, water glass and the like. It is formed by coating on a part of outer surface 2b of the funnel part 2. The exterior conductive film 8 is electrically separated from the anode terminal 6. The stem 9 has plural conductive pins 10 having continuity to the electron gun and arranged in a circular shape. The stem 9 hermetically seals an open end of the neck part 3 on the opposite side to the funnel part 2. The evacuated envelope 11 has its outer part formed by the panel part 1, the funnel part 2, the neck part 3, the anode terminal 6 and the stem 9 in a surrounding manner, and its inside is exhausted to a vacuum.

The deflector 12 has a deflection yoke. The deflector 12 deflects the single electron beam 5 into an X-direction (horizontally) and Y-direction (vertically) by using the deflection yoke and causes it to collide with the fluorescent screen la formed on the inner surface of the panel part 1, thus forming a required image.

FIG. 6 is a schematic plan view for explaining an exemplary image reproducing system of the projection display device using the projection cathode ray tubes. Reference signs rPRT, gPRT, and bPRT denote projection cathode ray tube devices for red, green, and blue. PNL are panels, which are image forming parts of the projection cathode ray tube devices. LNS are projection lenses. SCR is a projection screen. In FIG. 6, on the central axis of the projection cathode ray tube device for green gPRT and at a position that is a predetermined distance away from its panel PNL, the projection screen SCR is arranged substantially perpendicularly to central axis and facing the panel PNL.

The projection cathode ray tube devices for red and blue, rPRT and bPRT, are arranged on the left and right sides within the same plane, with the projection cathode ray tube device for green gPRT provided between them. Their central axes are fixed at angles that enable these axes to coincide with the central axis of the central projection cathode ray tube device for green gPRT on the projection screen SCR.

In forward parts of the respective panels of the projection cathode ray tube devices rPRT, gPRT, and bPRT, the projection lenses LES are arranged on the same lines as the axial lines of the respective cathode ray tube devices. Single-color images formed on the respective panels are enlarged, projected onto the screen SCR, and superimposed on each other, thus forming a color image.

The conventional projection cathode ray tube device and the projection display system are disclosed in detail in JP-A-2004-253352.

FIG. 7 is a schematic sectional view showing a conventional projection cathode ray tube device that employs a liquid cooling system, which is equivalent to the disclosure of Japanese Patent No. 2,904,190, FIG. 1(b). FIG. 8 is a schematic plan view showing a part of the outer appearance of FIG. 7 and for explaining the positional relation between an anode terminal 6, a protrusion 13 and a metal holding member 16. In FIG. 7 and FIG. 8, the same elements as in the above-described drawings are denoted by the same reference numerals.

In FIG. 7 and FIG. 8, plural protrusions 13 are arranged at predetermined intervals on the outer circumference of the outer wall surface 2b of the funnel part 2. These protrusions 13 are used for holding a liquid cooling mechanism 14 arranged on and adhering to the outer surface of the panel part 1.

When bringing a liquid refrigerant 15 in contact with the panel part 1 and thus cooling it, the metal holding member 16 is abutted against the protrusions 13, and it is tightened by screws 17 and 18, thus attaching the liquid cooling mechanism 14 to the projection cathode ray tube device. The metal holding member 16 has a central opening 16a of a size that allows insertion of the neck part 3 and a part of the funnel part 2, and it is not in contact with the funnel part 2 except for the parts where the protrusions 13 are provided. A reference numeral 19 is a radiation board. Moreover, JP-A-2001-93420 discloses an improvement in browning characteristics and a technique of cleaning the inner surface of a valve.

### SUMMARY OF THE INVENTION

In the projection cathode ray tube device having the cooling mechanism as described above, anode leak failure occurs and this causes deterioration in cathode ray tube display definition due to variance in anode voltage, damage to circuit components of the projection display device, and so on. Measures must be taken to address these problems.

The inventors have confirmed that the anode leak failure is due to the reduction in resistance value around the anode terminal 6 that is hermetically embedded in the funnel part 2 of the evacuated envelope 11 shown in FIG. 7 and FIG. 8 and that is partly exposed to the outer wall surface 2b of the funnel part 2.

A desirable resistance value around the anode terminal 6 is usually 10¹¹ Ω to 10¹² Ω. However, foreign matter, having a thickness of approximately 1 μm or less and made up of a deposited substance 20 containing PbO, Na and K-rich glass, remains around the anode terminal 6, as shown in FIG. 8, and it is considered that moisture absorption of this deposited substance 20 or its discoloration due to the moisture absorption is an element that lowers the resistance value.

Particularly the outer wall surface 2b of the funnel part of the valve is in an environment where it is constantly exposed to the atmosphere even after it is mounted in the projection display device following the cathode ray tube manufacturing process. Therefore, it is a difficult situation where the moisture absorption is constantly unavoidable throughout the operation and standby state. The presence of foreign matter such as the moisture-absorptive deposited substance 20.

On the other hand, the inner wall surface 2a of the funnel part, when it has been cleaned, is constantly situated in a closed space even after exhaustion. Therefore, there is no risk of moisture absorption after that. In this manner, the conditions are totally difference between the inner and outer surfaces of the valve with respect to the measures to deal with moisture absorption due to the presence of foreign matter.

If the resistance value around the anode terminal 6 is lowered to approximately 10⁹ Ω for the above reasons, discharge occurs between the anode terminal 6, and the exterior conductive film 8 and the metal holding member 16 of the liquid cooling mechanism. This causes anode leak failure. As this anode leak failure occurs, the anode voltage changes and deterioration in display definition emerges. There is also a problem of damage to the circuit components of the projection display device, and this needs to be addressed.

According to this invention, foreign matter such as a moisture-absorptive deposited substance adhering to a vicinity part of an anode terminal on an outer wall surface of a funnel part of a projection cathode ray tube device is removed by washing the vicinity part of the anode terminal with a hydrofluoric acid solution, and occurrence of unwanted discharge is restrained, thus preventing occurrence of anode leak failure.

This invention can realize a projection cathode ray tube device that enables projection of a stable and high-definition image having no variance in anode voltage by preventing occurrence of anode leak failure. Also, damage to circuit components of a projection display device can be avoided and a projection display device having excellent reliability can be provided.

### BRIEF DESCRIPTION OF THE DRAWINGS

FIG. 1A is a schematic plan view showing an exemplary projection cathode ray tube device manufactured by a manufacturing method of this invention, as viewed from the rear side of the projection cathode ray tube device.

FIG. 1B is a sectional view showing essential parts of FIG. 1A.

FIG. 2 is a schematic sectional view showing essential parts of the projection cathode ray tube shown in FIGS. 1A and 1B.

FIG. 3 is a schematic front view of a vertical setting for explaining a method for manufacturing a projection cathode ray tube of this invention.

FIG. 4 is a schematic front view of a horizontal setting for explaining a method for manufacturing a projection cathode ray tube valve according to this invention.

FIG. 5 is a schematic sectional view for explaining an exemplary structure of a projection cathode ray tube device.

FIG. 6 is a schematic plan view for explaining an exemplary reproduction system of a projection display device.

FIG. 7 is a schematic sectional view showing an example of a conventional liquid-cooling projection cathode ray tube valve.

FIG. 8 is a schematic plan view showing a part of the appearance of FIG. 7.

### DETAILED DESCRIPTION OF THE PREFERRED EMBODIMENTS

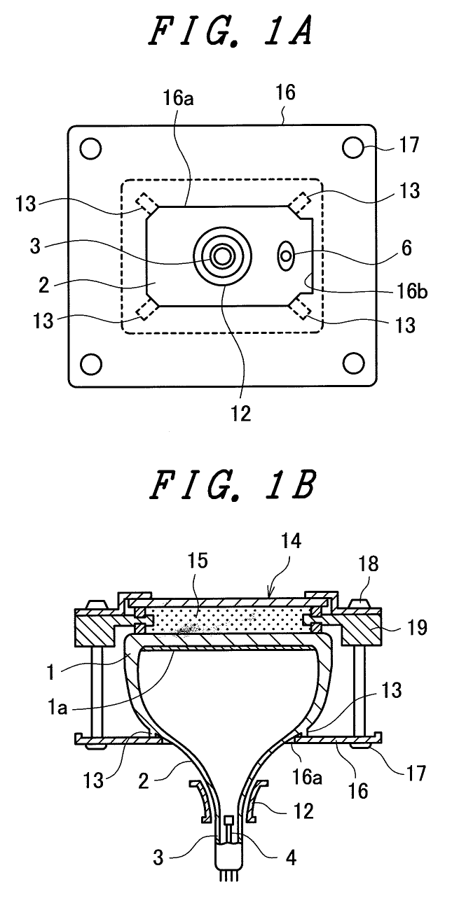

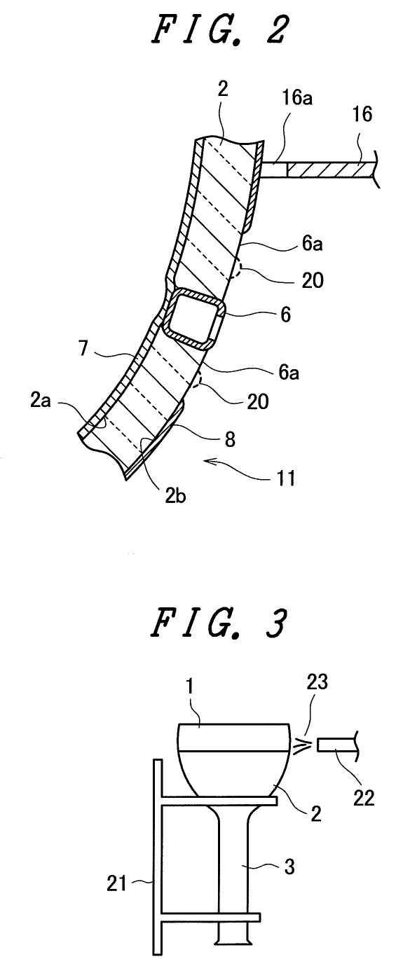

Hereinafter, an embodiment of carrying out the invention will be described in detail with reference to FIGS. 1A and 1B and FIG. 2.

### Embodiment 1

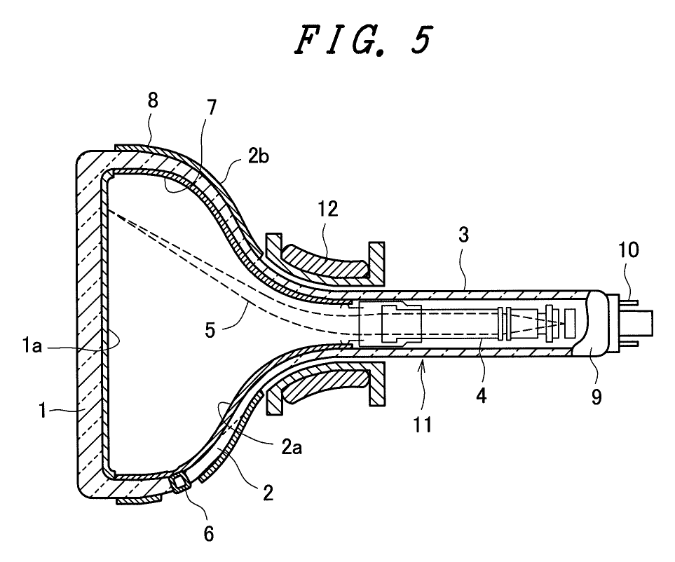

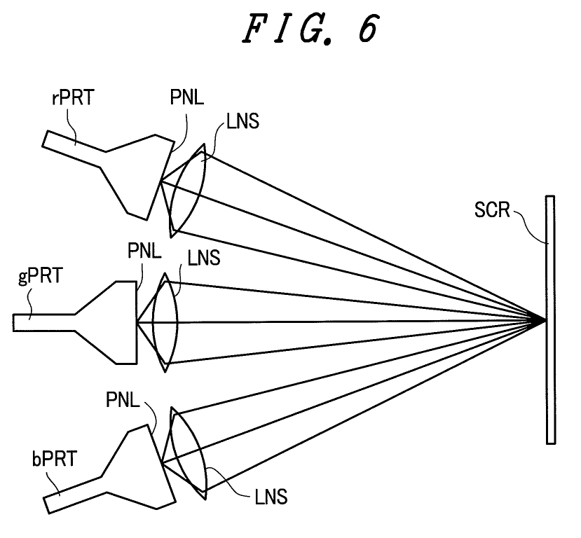

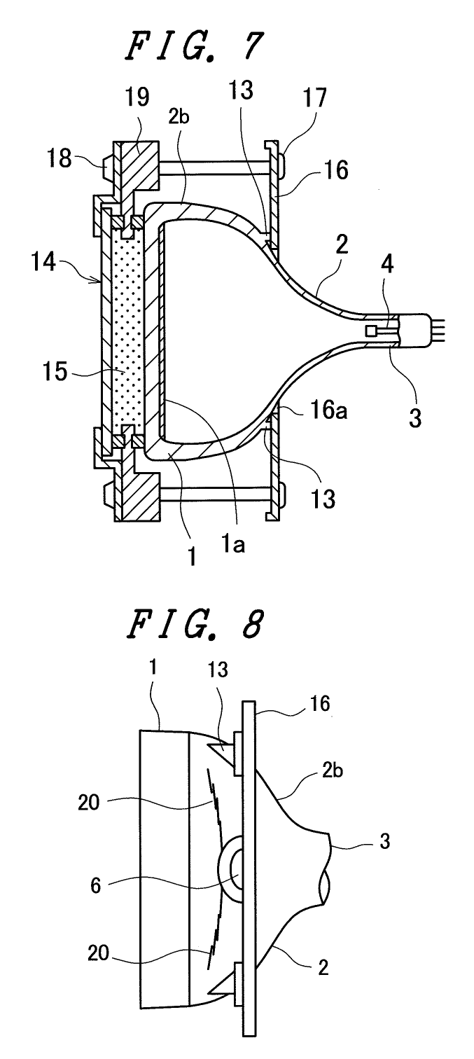

This invention is applied to the projection type cathode ray tube of FIG. 5, and the projection cathode ray tube displays an image in accordance with the image reproduction system of FIG. 6. FIG. 5 is a schematic sectional view showing a projection cathode ray tube device used for a projection display device, as described above. FIG. 6 is a schematic plan view showing an image reproduction system of the projection display device, as described above.

FIGS. 1A and 1B are views for explaining Embodiment 1 of a projection cathode ray tube device manufactured by the method according to this invention. FIG. 1A is a schematic plan view of the projection cathode ray tube device, as viewed from its rear side. FIG. 1B is a sectional view showing essential parts of FIG. 1A. FIG. 2 is a schematic sectional view showing essential parts of FIGS. 1A and 1B. In FIGS. 1A, 1B and 2, the same parts as in the above-described drawings are denoted by the same reference numerals.

The projection cathode ray tube according to this invention includes an evacuated envelope 11 that has a panel part 1, a neck part 3, a funnel part 2 connecting the panel 1 with the neck 3, a stem 9 connected to an open end of the neck 3 on the opposite side to the funnel 2, an anode terminal 6 embedded in the funnel 2, an interior conductive film 7 arranged on an inner wall surface 2a of the funnel 2 and having continuity to the anode terminal 6, and an exterior conductive film 8 arranged on an outer wall surface 2b of the funnel 2.

The panel 1 has, on its inner surface, a phosphor screen la on which an image is to be displayed. The neck 3 houses an electron gun 4 that emits a single electron beam 5 toward the phosphor screen 1a. A deflecting yoke 12 that deflects the electron beam 5 horizontally and vertically is provided on the outer side of a part near a transition area between the neck 3 and the funnel 2. A method for manufacturing such a projection cathode ray tube includes a step of washing a vicinity part 6a of the anode terminal 6 in the outer wall surface 2b of the funnel 2 with a hydrofluoric acid solution.

Also, a method for manufacturing a projection cathode ray tube valve (envelope) according to this invention is characterized by carrying out the step of washing the vicinity part 6a of the anode terminal 6 in the outer wall surface 2b of the funnel 2 with the hydrofluoric acid solution, prior to forming the exterior conductive film 8. In FIGS. 1A, 1B and 2, plural protrusions 13 are arranged at predetermined intervals on the outer wall surface 2b of the funnel 2. These protrusions 13 are used for holding a liquid cooling mechanism 14 arranged on and adhering to the outer surface of the panel 1.

When bringing a liquid refrigerant 15 in contact with the panel 1 and thus cooling it, a metal holding member 16 is abutted against the protrusions 13, and it is tightened by screws 17 and 18, thus attaching the liquid cooling mechanism 14 to the projection cathode ray tube valve. The metal holding member 16 has a central opening 16a of a substantially rectangular shape with a size that allows insertion of the neck 3 and a part of the funnel 2, and it is not in contact with the funnel part 2 except for the parts where the protrusions 13 are provided. Particularly, this central opening 16a has its end opening 16b expanded further in the area facing the anode terminal 6, thus improving voltage resistance property. The vicinity part 6a, toward the outerwall surface 2b, of the anode terminal 6 embedded hermetically in the funnel 2 is washed with the hydrofluoric acid solution, and a deposited substance indicated by a dotted line which has adhered to the vicinity part 6a on the outer wall surface 2b in manufacturing the valve is removed by the washing. The exterior conductive film 8 is arranged around the vicinity part 6a of the anode terminal 6. The exterior conductive film 8 and the interior conductive film 7 arranged on the inner wall surface 2a form a capacitance.

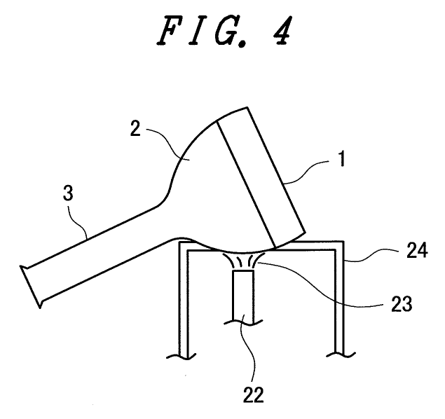

FIG. 3 and FIG. 4 are views for explaining methods of manufacturing the projection cathode ray tube valve of this invention. FIG. 3 is a schematic front view of a vertical setting. FIG. 4 is a schematic front view of a horizontal setting. The same parts as in the above-described drawings are denoted by the same reference numerals.

First, in the method shown in FIG. 3, the following steps are carried out.

(1) The valve prior to being sealed with the stem 9 is held in a vertical setting on a washing jig 21, with the axis of the tube being vertical and with the panel 1 facing up.

(2) A water wetting step is carried out. That is, the outer wall surface 2b of the funnel 2 is wetted with water such as industrial water. The time for this is, for example, approximately 15 seconds.

(3) A hydrofluoric acid solution 23, for example, with a concentration of 2%, is ejected from a nozzle 22 to wash the vicinity part of the anode terminal on the outer wall surface 2b of the funnel 2. The washing time is, for example, approximately 15 seconds.

(4) Next, the washed part is washed again, for example, with industrial water or the like. The time for this water washing is, for example, approximately 15 seconds.

(5) The washed part is further washed with pure water. This washing with pure water completely removes the hydrofluoric acid solution, and stops the reaction of the hydrofluoric acid solution and the glass. The time for this pure-water washing is, for example, approximately 15 seconds.

(6) After that, drying with hot air is carried out to complete the washing. The time for this hot-air drying is, for example, approximately 15 seconds.

In the method shown in FIG. 4, the following steps are carried out.

(1) The valve is held in a horizontal setting on a washing jig 24, with the axis of the valve being inclined.

(2) A water wetting step is carried out. That is, the outer wall surface 2b of the funnel part 2 is wetted with water such as industrial water. The time for this is, for example, approximately 15 seconds.

(3) A nozzle 22 is arranged facing up. A hydrofluoric acid solution 23, for example, with a concentration of 2%, is ejected from the nozzle 22 to wash the vicinity part of the anode terminal on the outer wall surface 2a of the funnel 2. The washing time is, for example, approximately 15 seconds.

(4) Next, the washed part is washed again, for example, with industrial water or the like. The time of this water washing is, for example, approximately 15 seconds.

(5) The washed part is further washed with pure water. This washing with pure water completely removes the hydrofluoric acid solution, and stops the reaction of the hydrofluoric acid solution and the glass. The time for this pure-water washing is, for example, approximately 15 seconds.

(6) After that, drying with hot air is carried out to complete the washing. The time for this hot-air drying is, for example, approximately 15 seconds.

In the horizontal setting shown in FIG. 4, the washing range can be specified more easily than in the vertical setting of FIG. 3. These washing steps can be carried out immediately after the valve is completed, but it is desired that these washing steps should be carried out before the exterior conductive film is formed, in view of operation efficiency, securing of the properties of the exterior conductive film and the like. It is desired that the concentration of the hydrofluoric acid solution is approximately 2%+0.5%.

In the description with reference to FIG. 3 and FIG. 4, the water washing with industrial water is carried out before and after the washing with the hydrofluoric acid solution. However, it is also possible to carry out the washing with pure water alone, without carrying out the water washing on the later stage. Other acids or alkalis may be used instead of the hydrofluoric acid solution.

This invention is not limited to the above-described configuration and the configuration of the embodiment, and various modifications and changes can be made without departing from the technical scope of the invention.

What is claimed is:

1. A method of manufacturing a projection cathode ray tube comprising a evacuated envelope that includes a panel, a neck, and a funnel connecting the panel with the neck,
the method including the step of washing a vicinity part of an anode terminal on an outer wall surface of the funnel with a hydrofluoric acid solution, the anode terminal being embedded in the funnel.

2. The method of manufacturing a projection cathode ray tube according to claim 1, wherein an exterior conductive film is formed after the step of washing the outer wall surface of the funnel with the hydrofluoric acid solution.
